(19) United States
(12) Patent Application Publication
(10) Pub. No.: US 2012/0048130 A1
(43) Pub. Date: Mar. 1, 2012

(54) Disposable Tea Bag Squeezer

(76) Inventor: John Ebenezer Mathew, Quincy, MA (US)

(21) Appl. No.: 13/220,563

(22) Filed: Aug. 29, 2011

Related U.S. Application Data
(60) Provisional application No. 61/377,619, filed on Aug. 27, 2010.

(51) Int. Cl. B30B 15/06

(52) U.S. Cl. 100/297

(57) ABSTRACT

A squeezing device allows a user to squeeze a teabag or other packet that has been soaked in a liquid. The squeezing device is substantially flat and has a pair of squeezing pads connected by a strip that is bendable. The squeezing pads receive a teabag there between when the pads are bent together such that a user exerts force directly against the teabag to drain its contents.

### CROSS REFERENCE TO RELATED APPLICATIONS

This application claims priority to and incorporates entirely by reference U.S. Provisional Patent Application Ser. No. 61/377,619 filed on Aug. 27, 2010.

### FIELD OF THE INVENTION

The invention relates to a hand-held mechanical device adapted to squeeze a teabag previously soaking in water. The device disclosed herein is also useful to squeeze other items that soak in a liquid to incorporate flavors or additives to the liquid.

### BACKGROUND OF THE INVENTION

Drinking beverages such as tea is common to multiple cultures across the globe. In the case of tea and similar beverages, the tea leaves add flavor to water, milk, or the like after soaking in the beverage for a suitable amount of time. A teabag or other porous device holds the tea leaves to retain the leaves while soaking in the liquid. When the tea has reached a desired strength, the device is removed and water or other liquid is drained from it. Most consumers prefer to squeeze the tea leaves or other flavoring substance after removing the teabag to make as much use as possible of the tea leaves and to return flavored liquid retained in the teabag back to the drink.

Normal practice is to position the tea-bag in a cup, pour the liquid, lift the bag and squeeze out the teabag using bare fingers or using silverware to squeeze the tea-bag. This practice is hazardous to consumer health, safety and sanitation and above all less efficient and less satisfying.

Prior apparatuses have addressed the issue that a consumer prefers to squeeze a porous flavouring bag, such as a teabag to take full advantage of its contents. For example, U.S. Pat. No. 4,286,514 (Wilson, 1981) shows a simple device used to compress a tea bag between tongs. The device is generally one piece and U-shaped with sufficient elasticity to allow the user to compress it without deforming the device permanently. The device incorporates finger tabs between the squeezing jaws and the fulcrum of the U-shaped body. Accordingly, the Wilson '514 device utilizes a Class 3 lever with the force of effort (E) located between the fulcrum and the load (l) of the teabag between the jaws. The Wilson '514 device, however, requires particular cut-outs or molds for manufacturing the ensure that the user places fingers on the tabs in the appropriate location.

Japanese Patent Publication 2004267698 (Ishikawa 2004) shows another kind of tea bag tongs with the squeezing jaws or pads positioned in a plane orthogonal to the arms of the device. The Ishikawa device omits any reference to particular finger tabs along the arms, but the way that the squeezing pads are arranged complicates manufacturing.

U.S. Pat. No. 4,153,153 (Herzog 1979) shows a squeezing apparatus that is incorporated into the tag and string used to dip a teabag into water. A folded cardboard portion of the teabag tag, attached to the teabag by a string, is configured to be separated from the tag, slide down the string and allow the user to squeeze the teabag with the folded cardboard. The Herzog '153 device, however, is limited in use to those teabags that have strings and tags, and many teabags or other permeable flavour packets do not have such strings.

Instead of an embodiment using tongs, United Kingdom Patent Application No. GB 2,171,634 (Nash 1986) uses an embodiment more similar to a nutcracker (i.e., second order levers with the load between the fulcrum and the effort). Nash perforates its squeezing plates that press against a teabag so that flavoured water can drain through the perforations.

Even in light of these prior developments, a need continues to exist in the art of teabag squeezers for a device that is easy to manufacture, convenient to use, and makes proper use of the mechanical advantage of leverage.

### SUMMARY OF THE INVENTION

In one embodiment, a squeezer for draining a porous packet soaked in a liquid after removing the packet from the liquid may include a pair of first and second squeezing pads connected by a strip attached to the respective pads at each end. The strip is bendable at a fulcrum, and the first and second squeezing pads have continuous surfaces for manually squeezing the packet without wetting or burning the user's fingers.

In another embodiment, a squeezer for draining a porous packet soaked in a liquid after removing the packet from the liquid includes a pair of squeezing pads connected by a bendable strip forming a fulcrum between the squeezing pads. The squeezing pads each have a first continuous surface that engages the porous packet and a second continuous surface opposite the first continuous surface for receiving a force squeezing the packet.

In yet another embodiment, a squeezer for draining a porous packet into a vessel has a pair of first and second squeezing pads connected by a strip attached to the respective pads at each end of the strip. The strip defines an indented region about which the strip bends, and the first and second squeezing pads have continuous surfaces for manually squeezing the packet.

### BRIEF DESCRIPTION OF THE FIGURES

FIG. 1 is a plan view of the tea bag squeezer according to the device disclosed herein.

FIG. 2 is a side view of the tea bag squeezer according to the device disclosed herein.

FIG. 3 is a perspective view of the tea bag squeezer according to the device disclosed herein and illustrates the foldable nature.

FIG. 4 is a perspective view of the tea bag squeezer according to the device disclosed herein with a partially folded configuration.

FIG. 5 is a perspective view of the tea bag squeezer according to the device disclosed herein in operation with a teabag squeezed into a cup.

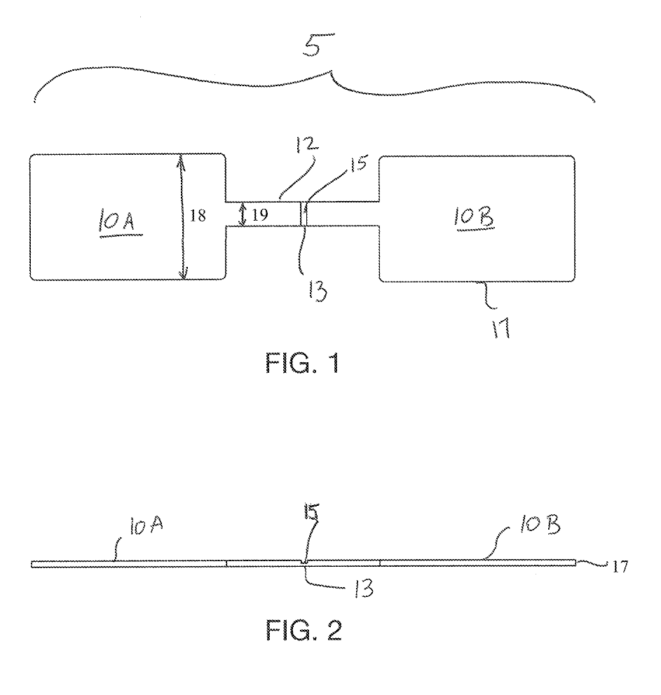

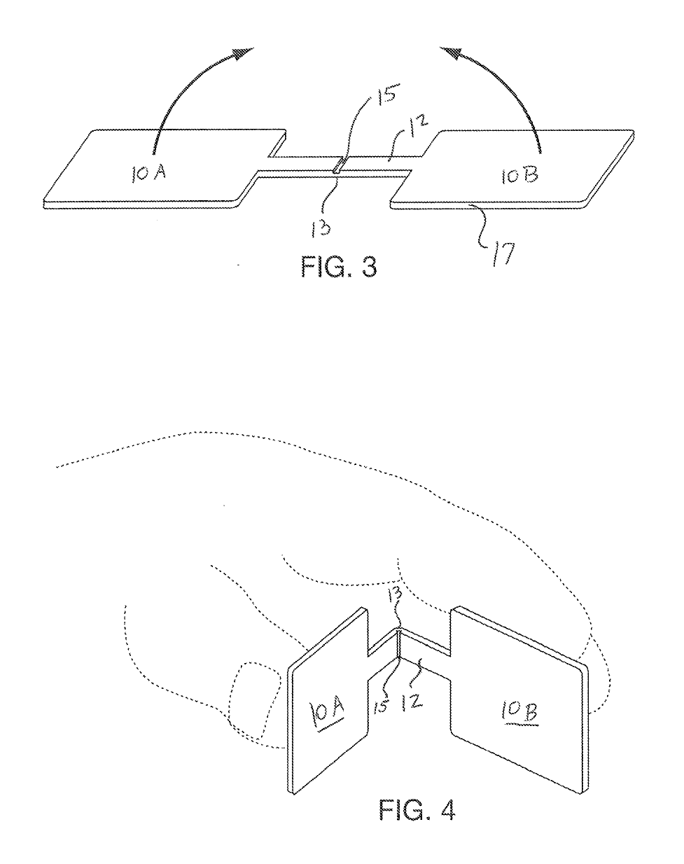

### DETAILED DESCRIPTION

This detailed specification refers to the device disclosed herein as a teabag squeezer, but the term is not limiting of the uses of the invention. The squeezer may be used to squeeze any perforated bag or packet intended to be soaked in a liquid to place flavors or other additives into the liquid, which is usually water. A teabag (20) would be a common but not exclusive use for the invention and references to teabags are used for easily understood examples without limiting the invention. In a first embodiment of the invention, as shown in the figures, the tea bag squeezer (5) is a single piece gadget. It essentially consists of two plastic pads (10A, 10B), substantially symmetrical in construction and connected by a thinner strip (12) which can be flexibly curved and bent to form a fulcrum (13). The strip (12) defines an indented or perforated region (15) that allows the squeezer (5) to be bent about its middle more easily. The squeezer (5) is substantially flat and may be made of nonwovens such as paper, plastics, metals, or any substance that is suitable for the use at hand.

In operation, as shown in FIG. 5, the teabag (20) is dunked into the cup (25) of hot water or hot milk and after a few seconds the consumer lifts it up by pulling up the thread attached to the teabag. The consumer, using the thumb against the index finger or the middle finger or both, applies a force gentle and slow enough onto the pads (10A, 10B), such that the tea within the teabag drains into the tea cup below. The size of the pads roughly conforms to or marginally exceeds the size of the soaked conventional single-cup teabag; at any rate, the gadget is simple, intuitive, handy and easy for manipulation.

The operation thus carried out, in the first place obviates necessity of the consumer's fingers ever touching the hot tea decoction or hot soaked teabag at any point of time. Secondly, the operation is performed fast and with maximum efficiency, delivering fresh tea, hot and clean, ready for consumption.

The figures illustrate that the squeezer (5) accomplishes the goal of draining a flavor packet or teabag (20) into a liquid in a container (25) and allows for squeezing the teabag or packet after it has been soaked in the liquid. The squeezer (5) takes full advantage of the concept of mechanical advantage as calculated for levers of all kinds The common use of levers divides them into classes or orders and named first order levers, second order levers, and third order levers. A first order lever, such as a see-saw, arranges the load (L) and the effort (E) used to move that load on opposite sides of a fulcrum. A second order lever, such as a wheelbarrow, uses an arrangement where the load in the basket is between the fulcrum (the front wheel of a wheelbarrow) and the effort used to lift the handles. A nutcracker uses two second order levers with the load close to the fulcrum and opposite the effort at the other end of the lever. A third order lever positions the effort between the fulcrum and the load (i.e., a pair of tweezers). All of these kinds of levers have a quantifiable mechanical advantage determined by the ratio of the force of the load over the force of the effort used to move the load.

The further away the effort (the squeezing force) is from the fulcrum (13) and the load (i.e., the teabag (20)), the greater the mechanical advantage of the lever. In this regard, one would expect that using a second order lever similar to a nutcracker arrangement would be the best choice for an efficient squeezer. A second order lever arrangement, however, requires that the teabag (20) be placed directly adjacent the fulcrum (13). The consumer then has to manipulate the teabag into the squeezer and push the teabag far enough into the device so that it is adjacent the fulcrum. This is not possible with a hot beverage such as tea.

Other ideas may utilize first order levers so that the squeezer works similarly to a pair of scissors. That arrangement requires moving parts and complicated manufacturing, however.

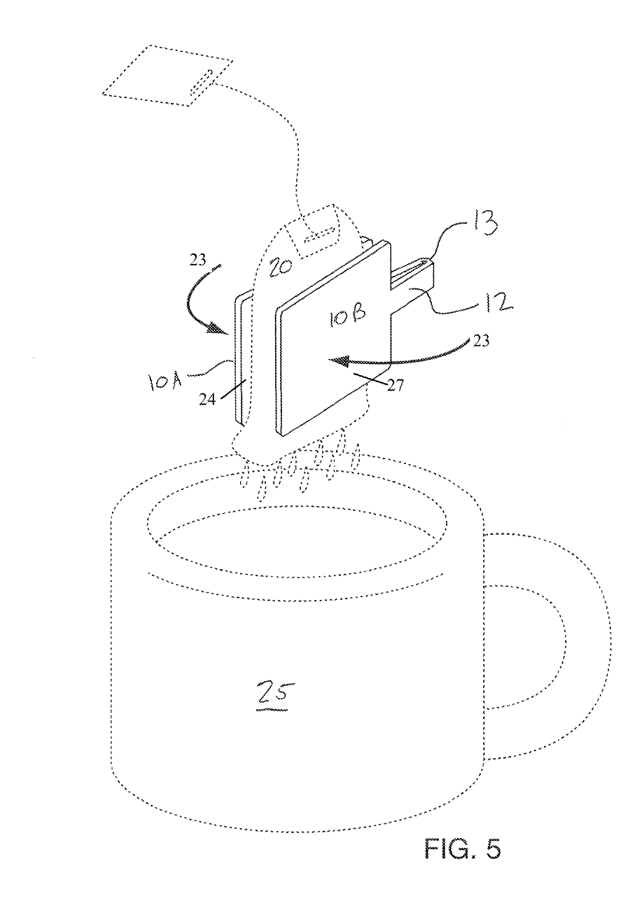

As shown in FIGS. 4 and 5, the device disclosed and claimed herein utilizes a third order lever that would traditionally exert the effort between the fulcrum and the load, similar to a pair of tweezers. In the embodiment of this device, however, the design of the squeezer encourages moving the load so that it is directly adjacent the effort of squeezing, thereby increasing the mechanical advantage of a third order lever. The load is directly under the effort of squeezing; the load and the effort are equidistant from the fulcrum (13).

The device is particularly useful in that it allows for bending the strip (12) connecting the squeezing pads (10A, 10B). In this way, the pads can be used to grab a teabag or other soaking bag or packet while it is in the hot water. The bag, such as a teabag, does not have to be re-positioned into the squeezer (5) in any particular fashion. After pinching the bag and pulling it out of the liquid, such as water, the squeezer (5) can be manually squeezed with the squeezing effort located directly over the teabag.

The squeezer (5) may be described as having a substantially flat, single plane construction that can be cut or molded as one piece. The strip (12) that connects the squeezing pads (10A, 10B) allows for less material to be used in the device because the width of the strip can be minimized. In one embodiment, the strip (12) has a width (19) that is less than half of the width (20) of the respective squeezing pads (10A, 10B). In other words, the strip (12) connects to respective squeezing pad widths (18) along a strip width (19). The strip width (19) may be an even smaller fraction of the squeezing pad width (18) of the squeezing pads (10A, 10B) to save materials without compromising functionality. In one embodiment, the squeezing pads (10A, 10B) and the strip (12) create a generally “H” shape with the strip being the narrow cross bar of the “H”. The strip (12) is bendable and can be of any dimensions, preferably as small as possible, because the strip will not be used to exert any effort or squeezing forces on the teabag. The front and back surfaces of the strip (12) are coplanar with those of the squeezing pads, which allows for the entire device to be made of a single sheet of material without requiring a cut and assembly manufacturing process. A single continuous cut can be used to make the device out of a sheet of material.

The squeezer is separated from the teabag and works with all kinds of bags and packets whether the bag has a string or other attachment. The nature of the bag is not limiting of the invention and can be any permeable, squeezable, soaking packet that includes teas, coffees, grasses, herbs, spices, or any product that is used to add flavors or particles to a liquid and squeezed afterwards.

Overall, the device disclosed herein may include, in one embodiment, a squeezer (5) for draining a porous packet (20) that has been soaked in a liquid such as water. The squeezer (5) is impermeable to the liquid so that when a user squeezes the packet, the liquid does not touch the user's fingers or hands. In this regard, the squeezing pads (10A, 10B) are continuous and uninterrupted (i.e., they do not have holes or openings). In fact, the squeezer may be a single body construction that has no openings from end to end. The single body construction may have a continuous outer edge (17) that allows for stamping, cutting, or molding the device in a simple fashion. The device may be cut from a nonwoven, molded from a polymer such as plastic, or may be formed of metals or any other sheet of material. Linear edges such as those shown in the drawings make manufacturing faster and more efficient.

The squeezing pads (10A, 10B) have front and back surfaces that are continuous and substantially flat on each side. The pair of squeezing pads are connected by a bendable strip (12) forming a fulcrum (13) between the squeezing pads, wherein the squeezing pads each comprise a first continuous surface (24) that engages the porous packet (25) and a second continuous surface (27) opposite the first continuous surface for receiving the force (23) squeezing the packet (20).

The invention is further embodied in the claims below.

1. A squeezer for draining a porous packet soaked in a liquid after removing the packet from the liquid, the squeezer comprising:
a pair of first and second squeezing pads connected by a strip attached to the respective pads at each end, wherein the strip is bendable at a fulcrum, wherein, the first and second squeezing pads comprise continuous surfaces for manually squeezing the packet.

2. A squeezer according to claim 1, wherein the squeezer is impermeable to liquids across its surface.

3. A squeezer according to claim 1, wherein said squeezing pads are substantially coplanar with said strip such that said squeezer is flat from one end to another before bending.

4. A squeezer according to claim 1, wherein said squeezer is formed of a nonwoven material.

5. A squeezer according to claim 1, wherein said squeezer is formed of a polymer.

6. A squeezer according to claim 1, wherein said squeezer further comprises edges that are substantially linear.

7. A squeezer according to claim 1, wherein said strip comprises respective strip widths at each end of said strip and connects to respective squeezing pad widths along said strip widths, wherein said strip widths are less than half the respective squeezing pad widths.

8. A squeezer according to claim 1, wherein said squeezer is perforated along a section of said strip such that said strip is bendable.

9. A squeezer according to claim 1, wherein said squeezer receives the packet for squeezing as a third order lever.

10. A squeezer for draining a porous packet soaked in a liquid after removing the packet from the liquid, the squeezer comprising:
a pair of squeezing pads connected by a bendable strip forming a fulcrum between the squeezing pads, wherein the squeezing pads each comprise a first continuous surface that engages the porous packet and a second continuous surface opposite the first continuous surface for receiving the force squeezing the packet.

11. A squeezer according to claim 10, wherein said squeezer receives the packet for squeezing as a third order lever.

12. A squeezer according to claim 11, wherein said lever comprises the porous packet as a load and receives the force squeezing the packet from the hand of a user.

13. A squeezer according to claim 12, wherein the load and the squeezing force are substantially equal distances from the fulcrum.

14. A squeezer according to claim 10, wherein the bendable strip defines an indention to promote bending.

15. A squeezer for draining a porous packet into a vessel, the squeezer comprising a pair of first and second squeezing pads connected by a strip attached to the respective pads at each end of the strip and forming a substantially “H” shaped device, wherein the strip defines an indented region about which the strip bends, and wherein the first and second squeezing pads comprise continuous surfaces for manually squeezing the packet.

16. A squeezer according to claim 15, wherein said squeezer comprises a front surface and a back surface that are nonporous.

17. A squeezer according to claim 16, wherein said squeezing pads are substantially square.

18. A squeezer according to claim 15, wherein the squeezing pads and the strip are of a substantially uniform thickness between the indented region and edges of the squeezer.

19. A squeezer according to claim 15, wherein the fulcrum defines a third order lever within the squeezer when a packet is between the squeezing pads.

20. A squeezer according to claim 19, wherein the packet is directly under the force of squeezing during use of the squeezer.
